(19) United States
(12) Patent Application Publication
(10) Pub. No.: US 2025/0388233 A1
(43) Pub. Date: Dec. 25, 2025

(54) Automated Driving System, Driving Regulation Method, and Driving Regulation Program

(71) Applicant: Hitachi Astemo, Ltd., Hitachinaka-shi, Ibaraki (JP)

(72) Inventors: Takahiro IKEDA, Tokyo (JP); Selya KATO, Tokyo (JP); Yasuhiro FUSE, Tokyo (JP); Akihiro KONDO, Tokyo (JP); Yoshitaka ATARASHI, Tokyo (JP)

(21) Appl. No.: 18/842,868

(22) PCT Filed: Apr. 14, 2023
(86) PCT No.: PCT/JP2023/015180

§ 371 Date: Apr. 18, 2025

(30) Foreign Application Priority Data
Jun. 22, 2022 (JP) 2022-100558

(51) Int. Cl. B60W 60/00

(52) U.S. Cl. CPC B60W 60/0015; B60W 2530/00; B60W 2552/00; B60W 2720/24

(57) ABSTRACT

An automated driving system, a driving regulation method, and a driving regulation program that make it possible to set risk areas accurately and thereby achieve safe automated driving are provided. Included are a risk area setting unit 111 that identifies a risk type from field information on planning or operation, recorded in an operational information database 101 and an infrastructure information database 103, and that sets a predetermined area in a field area, as a risk area, on the basis of the risk type, and a vehicle route setting unit 117 that sets a traveling route for a vehicle 2 traveling in the field area, on the basis of vehicle position information of the vehicle 2 and the risk area set by the risk area setting unit 111.

### TECHNICAL FIELD

The present invention relates to an automated driving system, a driving regulation method, and a driving regulation program.

### BACKGROUND ART

There is an infrastructure-cooperative automated driving system that uses infrastructure information detected by infrastructure sensors installed in a field, to automatically drive vehicles in the field. Unlike a control method that uses sensors on the vehicle itself (on-board sensors), the infrastructure-cooperative automated driving system can ensure safety against accident factors that are difficult to avoid with on-board sensors alone, such as objects jumping out of the blind spot of the on-board sensors, by installing infrastructure sensors on the field. Using field information from infrastructure sensors enables the automated driving system to recognize object information (hazard information) regarding the many areas where the system performs control/management.

Incidentally, a dangerous state from the acquired information has variation depending on the type of risk that constitutes the dangerous state. For example, a dangerous state caused by an accident increases the hazard potential in the surrounding area due to the accident response, etc. Hence, it is necessary to set a wide area as a hazardous area (also called a risk area) due to the dangerous state. Moreover, when the risk value of a specific area in the set wide hazardous area decreases, it is necessary to partially cancel the hazardous area setting of the area where the risk value has decreased, from the viewpoint of productivity.

A known technique for vehicle control/operation management that takes such area risks into account is disclosed in Patent Document 1.

Patent Document 1 describes a problem that “at the time of executing processing for areas where dangerous states occur frequently, despite the event being a single sudden braking event, the frequency of occurrence increases, and the area is erroneously recognized as being a place where dangerous states occur frequently,” and describes, as a solution, a method in which “a first time and a first occurrence location at which a dangerous state occurred in a first vehicle and a second time and a second occurrence location at which a dangerous state occurred in a second vehicle are extracted from vehicle traveling information, and when it is detected that the extracted first time and second time are within a predetermined time width and that the first occurrence location and the second occurrence location are within a predetermined distance range, a process is executed to integrate the occurrence of the dangerous state in the first vehicle and the occurrence of the dangerous state in the second vehicle and count these events as occurrence of a single dangerous state.”

### PRIOR ART DOCUMENT

### Patent Document

Patent Document 1: JP-2015-075791-A

### SUMMARY OF THE INVENTION

### Problems to be Solved by the Invention

The conventional technology described in the above-mentioned Patent Document 1 prevents the expansion of dangerous areas by integrating the numbers of safety control in dangerous situations such as sudden braking, but since the dangerous areas are determined only based on the sudden braking events, there is a possibility that dangerous areas will be overlooked due to incorrect determination.

The present invention has been made in consideration of the above-mentioned circumstances, and an object thereof is to provide an automated driving system, a driving regulation method, and a driving regulation program that can accurately set risk areas to achieve safe automated driving.

### Means for Solving the Problems

In order to solve the above problems, the automated driving system according to the present invention is characterized by having an operational information database that records operational information related to operating plans or operational changes in a field area, an infrastructure information database that records infrastructure information from infrastructure sensors in the field area, a risk area setting unit that identifies a risk type from field information on planning or operation, recorded in the operational information database and the infrastructure information database, and sets a predetermined area of the field area, as a risk area, on the basis of the risk type, and a vehicle route setting unit that sets a traveling route for a vehicle traveling in the field area, on the basis of vehicle position information of the vehicle and the risk area set by the risk area setting unit.

In addition, the driving regulation method according to the present invention is characterized by having an operational information recording step of recording operational information related to operating plans or operational changes in a field area, an infrastructure information recording step of recording infrastructure information from infrastructure sensors in the field area, a risk area setting step of setting a predetermined area of the field area, as a risk area, on the basis of a risk type, after identifying the risk type from field information on planning or operation, recorded in the operational information recording step and the infrastructure information recording step, and a vehicle route setting step of setting a traveling route for a vehicle traveling in the field area, on the basis of vehicle position information of the vehicle and the risk area set in the risk area setting step.

In addition, the driving regulation program according to the present invention is characterized by causing a computer to execute an operational information recording procedure for recording operational information related to operating plans or operational changes in a field area, an infrastructure information recording procedure for recording infrastructure information from infrastructure sensors in the field area, a risk area setting procedure for setting a predetermined area of the field area, as a risk area, on the basis of a risk type, after identifying the risk type from field information on planning or operation, recorded in the operational information recording procedure and the infrastructure information recording procedure, and a vehicle route setting procedure for setting a traveling route for a vehicle traveling in the field area, on the basis of vehicle position information of the vehicle and the risk area set in the risk area setting procedure.

### Advantages of the Invention

According to the present invention, risk types are identified from field information and risk areas are set from the field area, so that risk areas can be set accurately to achieve safe automated driving.

The problems, configurations, and effects other than those described above will become apparent from the following description of the embodiments.

### BRIEF DESCRIPTION OF THE DRAWINGS

FIG. 1 is a schematic configuration diagram of an automated driving system according to an embodiment of the present invention.

FIG. 2 is a configuration diagram of the automated driving system according to the embodiment of the present invention.

FIG. 3 is an explanatory diagram of a risk type DB.

FIG. 4 is an explanatory diagram of a risk area range DB.

FIG. 5 is an explanatory diagram of an area risk value list DB.

FIG. 6 is an explanatory diagram of an operation example of the risk area setting of a risk area setting unit.

FIG. 7 is an explanatory diagram of an operation example of the risk area setting unit to cancel (reset) a risk area.

FIG. 8 is an explanatory diagram of an operation example of the risk area setting unit and a vehicle route setting unit (risk area due to occurrence of an accident).

FIG. 9 is an explanatory diagram of an operation example of the risk area setting unit and the vehicle route setting unit (risk area due to a sensor blind spot or an equipment failure).

FIG. 10 is an explanatory diagram of an operation example of the risk area setting unit and the vehicle route setting unit (risk area due to a person and a manned vehicle).

FIG. 11 is an explanatory diagram of a display example of a display screen of an information display unit.

FIG. 12 is a flowchart of a main routine of a control device.

FIG. 13 is a flowchart of a subroutine of a control device (risk area setting process).

### MODE FOR CARRYING OUT THE INVENTION

Hereinafter, an embodiment of the present invention will be described with reference to the drawings.

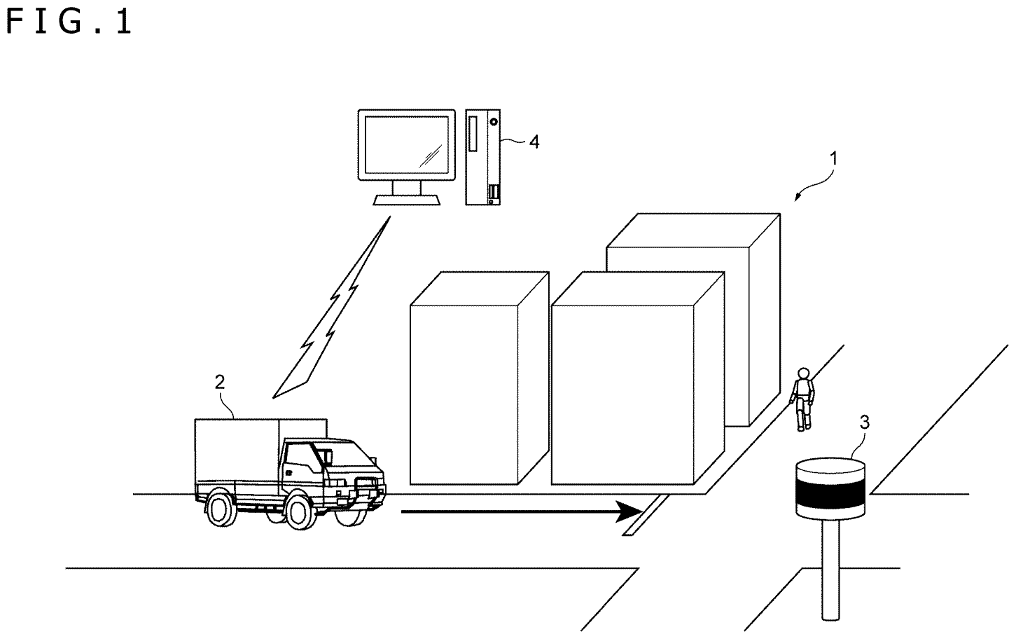

FIG. 1 is a schematic configuration diagram of an automated driving system 1 according to an embodiment of the present invention.

The automated driving system 1 includes a vehicle (automated driving vehicle) 2, an infrastructure sensor 3, and a control device 4.

The vehicle (automated driving vehicle) 2 performs automated driving for driving by itself in a field area, which is a traveling area, by receiving traveling route information from the control device 4. Note that the vehicle (automated driving vehicle) 2 may perform automated driving in the field area under a predetermined situation by using information acquired by sensors mounted on the vehicle 2, map information, etc. Also, the vehicle (automated driving vehicle) 2 may output vehicle position information detected with use of information acquired by sensors mounted on the vehicle 2, map information, etc. to the control device 4.

The infrastructure sensor (also referred to as a field sensor) 3 is a sensor for detecting objects (target objects) in the field area. The infrastructure sensor 3 includes a camera, a LiDAR, or a radar, for example, installed in the field area. The infrastructure sensor 3 outputs detection information concerning objects in the field area (hereinafter also referred to as infrastructure information) to the control device 4. Further, the infrastructure sensor 3 may also detect the vehicle 2 traveling in the field area and output the vehicle position information to the control device 4.

The control device 4 sets a traveling route for the vehicle 2 in the field area on the basis of detection information (infrastructure information) from the infrastructure sensors 3, and transmits the set traveling route to the vehicle 2 via wireless communication.

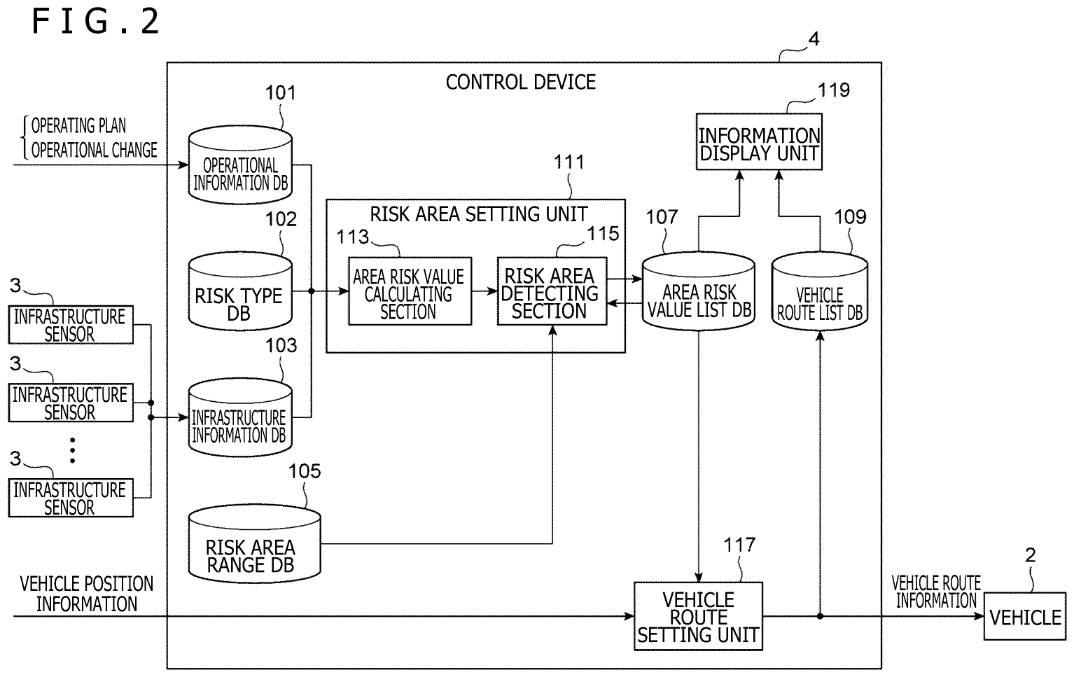

FIG. 2 is a configuration diagram of the automated driving system 1 according to an embodiment of the present invention, and in particular illustrates an internal configuration of the control device 4.

The control device 4 of the automated driving system 1 includes, as storage units, an operational information database (DB) 101, a risk type database (DB) 102, an infrastructure information database (DB) 103, a risk area range database (DB) 105, an area risk value list database (DB) 107, and a vehicle route list database (DB) 109, and as functional units, a risk area setting unit 111, a vehicle route setting unit (also referred to as a rerouting unit) 117, and an information display unit 119. The risk area setting unit 111 has an area risk value calculating section 113 and a risk area detecting section 115.

The operational information DB 101 stores (records) operational information related to operating plans or operational changes input or transmitted by the system operator. The operational information here includes field information on planning such as the maintenance information for the road and equipment in the field area.

The infrastructure information DB 103 stores (records) detection information (infrastructure information) obtained by the infrastructure sensor 3. The infrastructure information here includes operational field information such as information on the presence or absence of people and vehicles (manned vehicles, automated driving vehicles, etc.) in the field area and information on sensor blind spots.

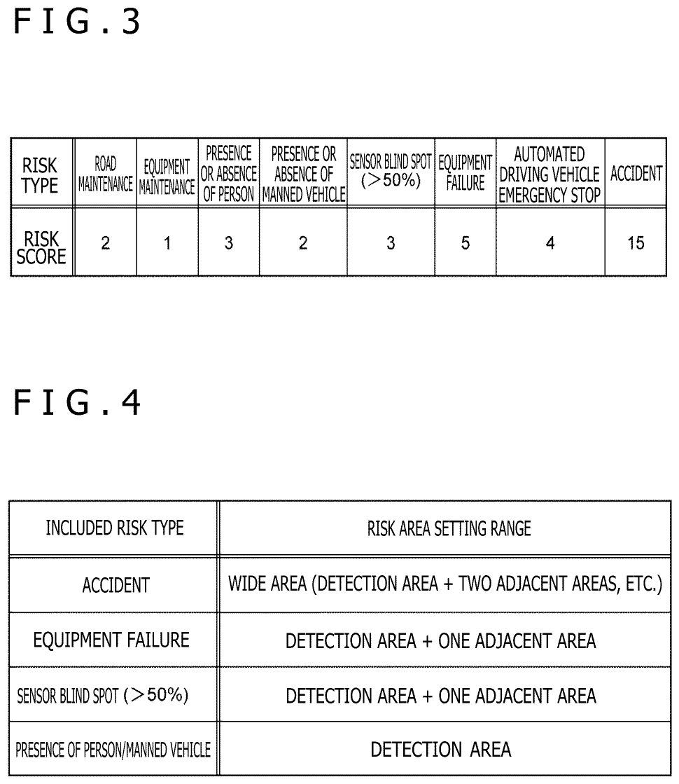

The risk type DB 102 stores (records) information on risk scores (risk values) for each risk type. As illustrated in FIG. 3, in the risk type DB 102, the risk values are managed separately for each risk type.

The risk area range DB 105 stores (records) a risk area range setting table that sets the range of the risk area on the basis of the risk type and the area risk value, as described below. The risk area range setting table is a table that specifies the relation between the risk type included in the detection area, which will be described later, and the risk area setting range, as illustrated in FIG. 4.

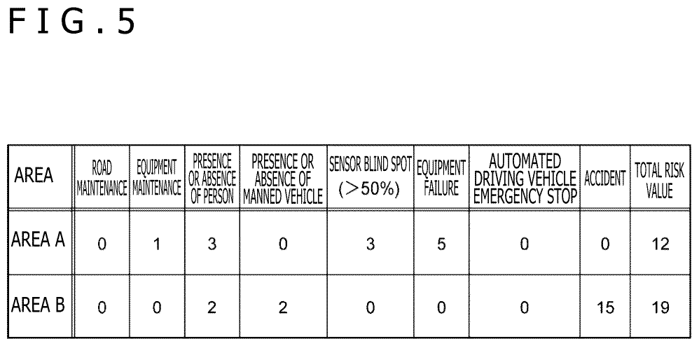

As illustrated in FIG. 5, the area risk value list DB 107 stores (records) area risk values (total risk values) calculated for each predetermined area set in advance in the field area, as well as information on risk areas set based on the area risk values and the risk types (details will be described later).

The vehicle route list DB 109 stores (records) information on the traveling route (vehicle route) for each vehicle 2 that is set based on the risk area as described below.

The area risk value calculating section 113 of the risk area setting unit 111 identifies a risk type from operational information related to operating plans or operational changes stored in the operational information DB 101 or detection information (infrastructure information) obtained by the infrastructure sensor 3 and stored in the infrastructure information DB 103, and calculates an area risk value for the entire area managed by the system (in other words, the detection area of the infrastructure sensor 3). The area risk value calculating section 113 calculates an area risk value based on the identified risk type, for each predetermined area set in advance in the field area. The area risk value calculating section 113 refers to the risk type DB 102 (FIG. 3) and determines the area risk value by the total value of the risk values of the identified risk types for each of the predetermined areas. The area risk value calculated for each predetermined area is stored in the area risk value list DB 107 (FIG. 5) together with the risk types constituting the area risk value.

The risk area detecting section 115 of the risk area setting unit 111 compares the area risk value calculated previously (last time or at a certain point in time) with the current area risk value, and in the case where a certain amount of change occurs, sets a risk area according to the risk type constituting the area risk value (in other words, according to the combination with the risk type constituting the area risk value). The combination with the risk type includes a combination where an accident has occurred, a combination where a person or a manned vehicle is present, a combination where a sensor blind spot exists, a combination where an equipment failure exists, etc. (also see FIG. 4).

To be specific, the risk area detecting section 115 compares the area risk value calculated previously (the last time or at a certain time point) with the current area risk value, and identifies, as a detection area, a predetermined area where the increase in the area risk value exceeds a predetermined amount of change.

The risk area detecting section 115 checks the risk area range setting table (FIG. 4) in the risk area range DB 105, and when the risk type constituting the area risk value of the detection area agrees with the risk type in the risk area range setting table, sets the risk area on the basis of the risk area setting range of the risk area range setting table. In the example illustrated in FIG. 4, in the case where “accident” is included as the risk type of the detection area, a wide area (such as the detection area+two adjacent areas, etc.) is set as the risk area. Also, in the case where “equipment failure” or “sensor blind spot” is included as the risk type of the detection area, the detection area+one adjacent area is set as the risk area. Also, in the case where “person” or “manned vehicle” is included as the risk type of the detection area, only the detection area is set as the risk area.

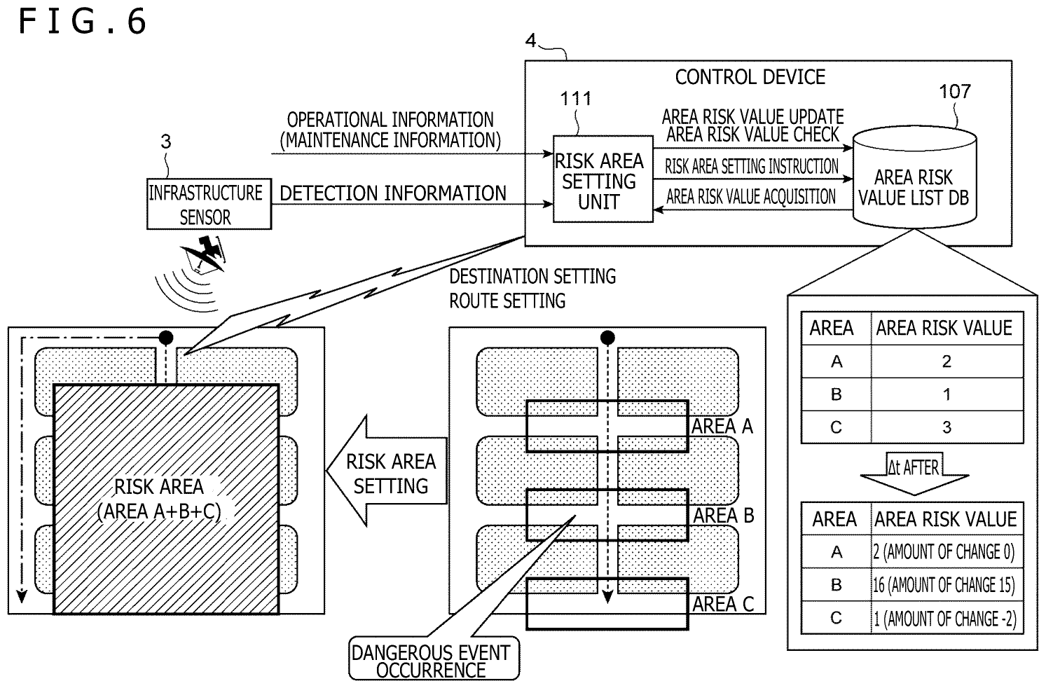

FIG. 6 illustrates an operation example of the risk area setting of the risk area setting unit 111. In the example illustrated in FIG. 6, as a result of the risk area setting unit 111 calculating the area risk value, a certain amount of change has occurred in area B (the increase in the area risk value has exceeded a predetermined amount of change). Further, for such reasons as “equipment failure” and “sensor blind spot” being included as the risk type of area B, area B as well as areas A and C adjacent to area B are set as risk areas.

In addition, the risk area setting unit 111 (the risk area detecting section 115 thereof) focuses on the amount of change in the area risk value for an area set as a risk area, and performs a risk area (re)setting to exclude the area from the risk area when the area risk value has a certain amount of decrease (in other words, when the amount of decrease in the area risk value of a predetermined area set as a risk area exceeds a predetermined amount of change).

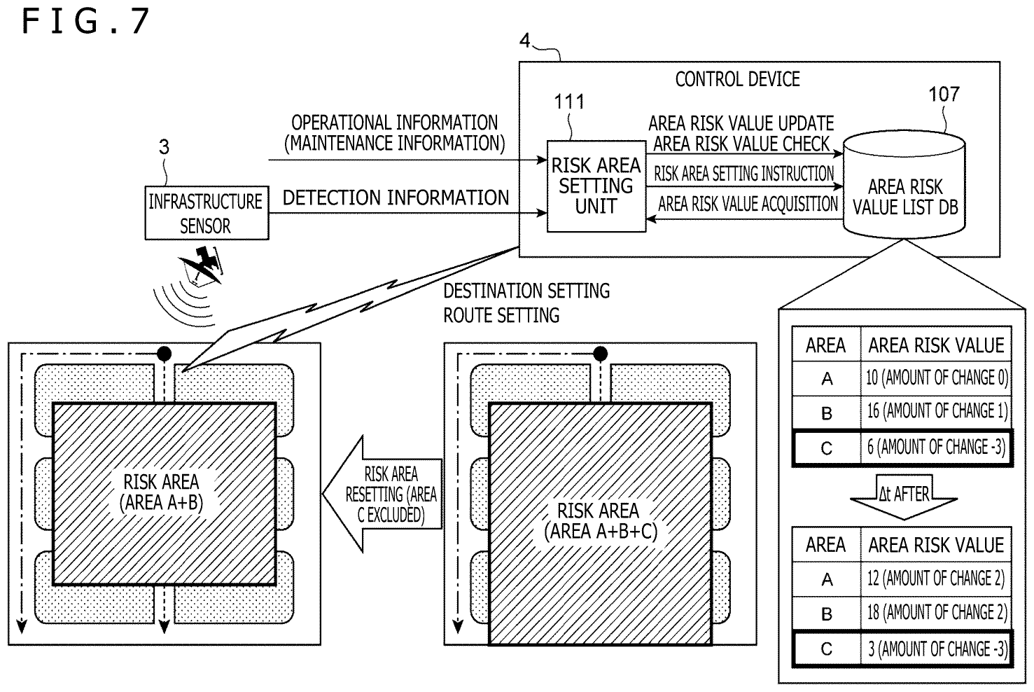

FIG. 7 illustrates an example of the operation of cancelling (resetting) a risk area in the risk area setting unit 111. In the example illustrated in FIG. 7, as a result of the risk area setting unit 111 calculating the area risk value, a certain amount of change has occurred in area C (the amount of decrease in the area risk value has exceeded a predetermined amount of change). Further, area C is excluded from the risk area, and a risk area is (re)set.

Information on the risk areas set by the risk area setting unit 111 (the risk area detecting section 115 thereof) is stored in the area risk value list DB 107 (FIG. 5).

The vehicle route setting unit 117 resets the traveling route of (reroutes) the vehicle 2 traveling in the field area, on the basis of the vehicle position information of the vehicle 2 traveling in the field area and the risk area information extracted from the area risk value list DB 107. As described above, the vehicle position information may be detected based on the detection information (infrastructure information) obtained by the infrastructure sensor 3, or may be detected with use of information acquired by a sensor mounted on the vehicle 2, map information, etc.

The vehicle route setting unit 117 sets traveling routes under different conditions for a vehicle that is in a risk area, a vehicle that is outside the risk area, and a vehicle that is scheduled to travel from outside the risk area into the risk area. In other words, the vehicle route setting unit 117 changes the traveling route of the vehicle 2 depending on whether the vehicle 2 is traveling inside or outside the risk area or traveling into the risk area from the outside.

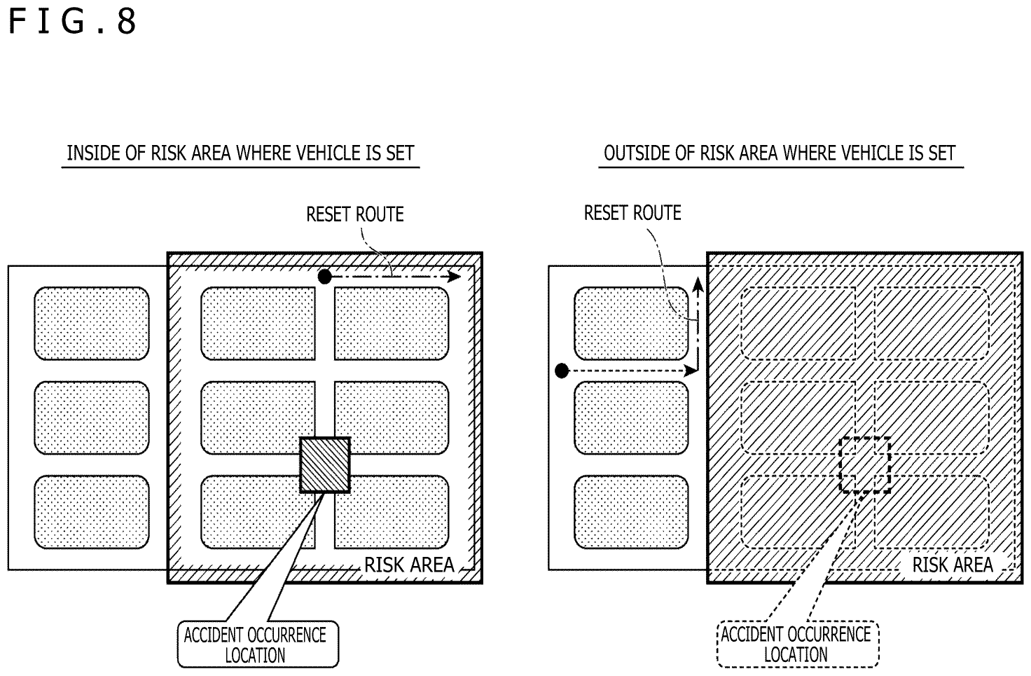

As described above, the risk area setting range differs depending on the type of risk in the area (risk area setting unit 111), and the rerouting methods for the vehicles 2 that are inside and outside the risk area differ from each other (vehicle routing unit 117). Specific examples of the rerouting method by the vehicle route setting unit 117 will be described for each type of risk (risk type) together with the risk area setting method of the risk area setting unit 111 by using FIGS. 8 to 10.

### (1) Risk Area Due to Accident Occurrence

When an accident occurs, the hazard potential (risk value) of a wide area increases significantly because a working vehicle and an emergency vehicle enter the area to respond to the accident. Hence, the risk area setting unit 111 sets the wide area including the accident occurrence location (detection area) (for example, the detection area +two adjacent areas, all areas used for vehicle travel to handle the accident) as a risk area (see the risk area range setting table in the risk area range DB 105 in FIG. 4).

In this case, the vehicle route setting unit 117 reroutes an automated driving vehicle that is present inside the risk area such that the vehicle swiftly exits the wide-area risk area (see the left diagram in FIG. 8).

In addition, the vehicle route setting unit 117 reroutes an automated driving vehicle that is outside a risk area such that the vehicle does not enter the wide-range risk area (see the right diagram in FIG. 8).

### (2) Risk Area Due to a Sensor Blind Spot and an Equipment Failure

When an equipment failure or a sensor blind spot occurs, a working vehicle enters the area to deal with the equipment failure or remove the sensor blind spot, so that the hazard potential (risk value) of the surrounding area increases.

Hence, the risk area setting unit 111 sets the surrounding area (for example, the detection area +one adjacent area) including the location where the dangerous event has occurred (detection area) as a risk area (see the risk area range setting table of the risk area range DB 105 in FIG. 4).

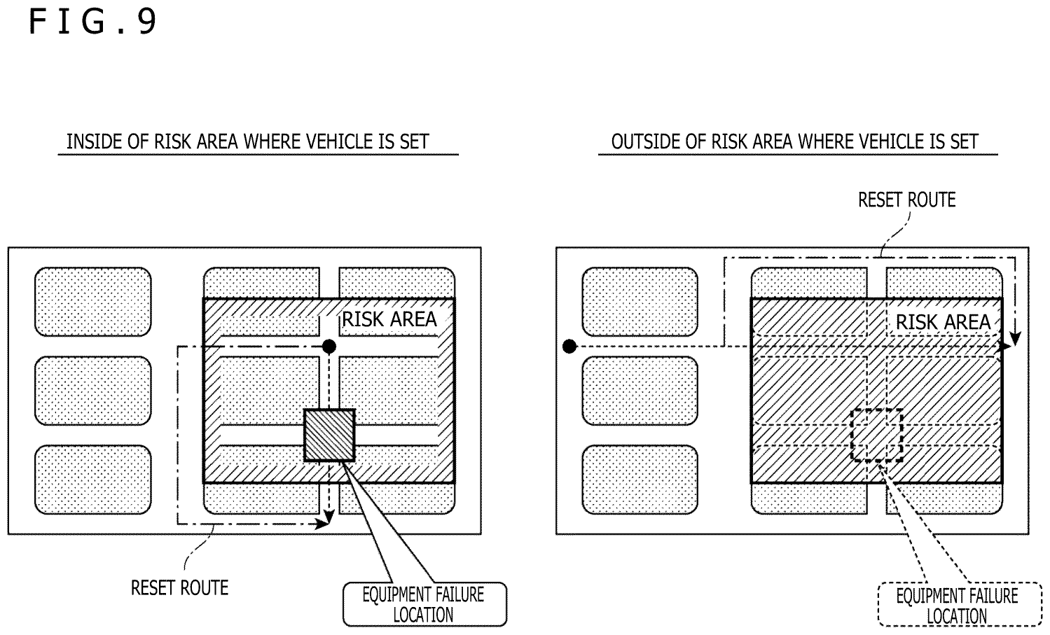

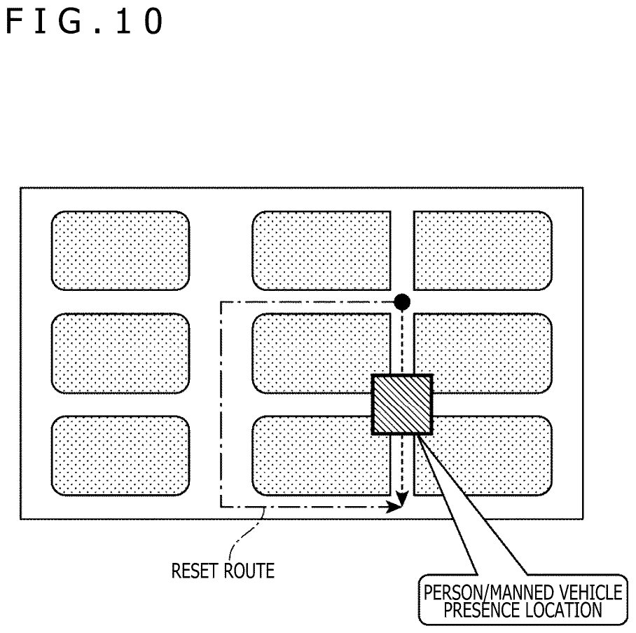

In this case, the vehicle route setting unit 117 reroutes an automated driving vehicle that is present inside the risk area such that the vehicle does not travel through the dangerous event occurrence area (see the left diagram in FIG. 9).

In addition, the vehicle route setting unit 117 reroutes an automated driving vehicle that is outside the risk area such that the vehicle does not enter the risk area (see the right diagram in FIG. 9).

### (3) Risk Area Due to People and Manned Vehicles

Even if there are many people and manned vehicles, there is no intrusion of a working vehicle etc., so that the hazard potential (risk value) of the surrounding area does not change. Hence, the risk area setting unit 111 sets only the location where the dangerous event has occurred (detection area) as a risk area (see the risk area range setting table in the risk area range DB 105 in FIG. 4).

In this case, the vehicle route setting unit 117 reroutes the automated driving vehicle such that the vehicle does not travel through the risk area, regardless of whether the vehicle is inside or outside the risk area (see FIG. 10). Information on the traveling route set by the vehicle route setting unit 117 is transmitted by wireless communication to the vehicle 2. The vehicle 2 can perform automated driving (automated travel) in the field area on the basis of the traveling route transmitted from the vehicle route setting unit 117.

Further, information on the traveling route set by the vehicle route setting unit 117 is stored in the vehicle route list DB 109.

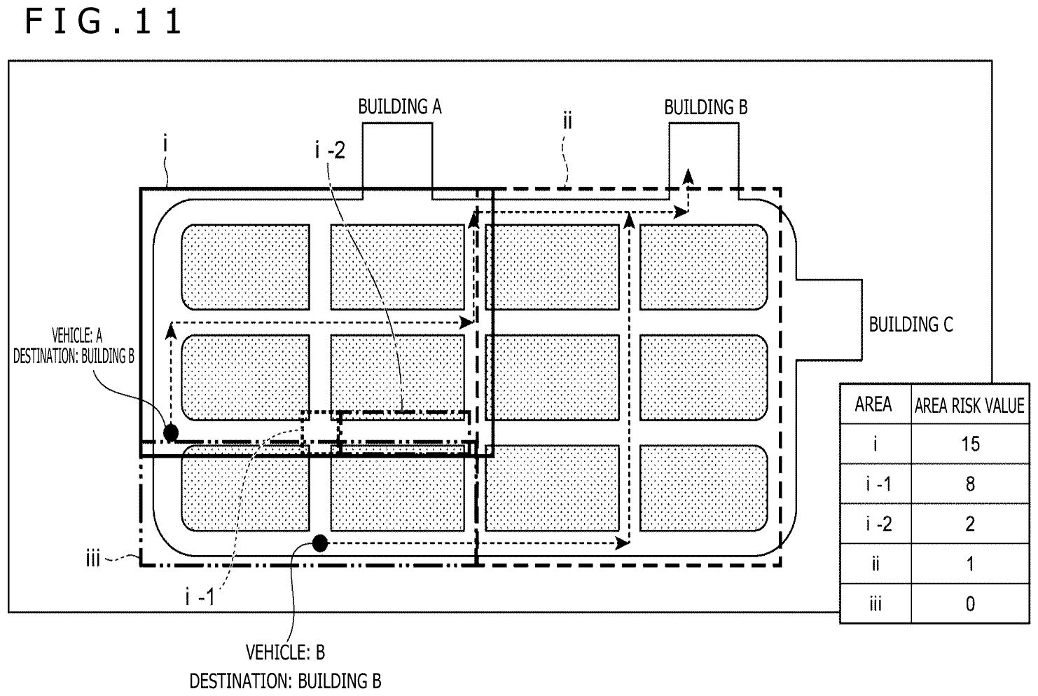

As illustrated in FIG. 11, for example, the information display unit 119 displays, on a display screen on the system operator's desk, the area risk value for each area in the field area, the set risk areas, the set traveling routes of each vehicle, etc., from the information stored in the area risk value list DB 107 and the vehicle route list DB 109. By referring to the display screen on the desk, the system operator can recognize the risk areas and modify the traveling routes of each vehicle, for example.

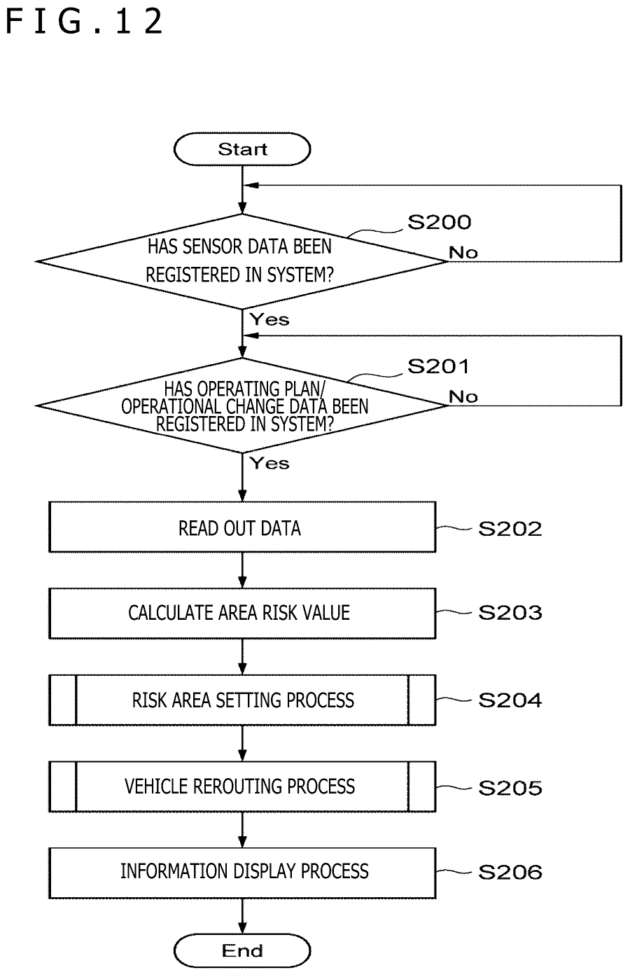

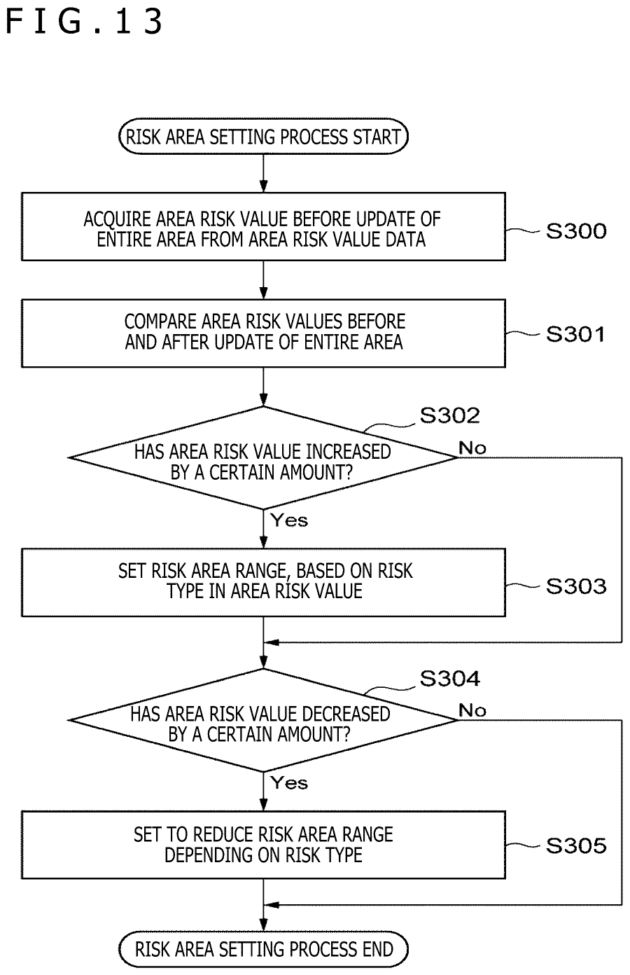

FIGS. 12 and 13 are flowcharts of a main routine and a subroutine (risk area setting process) of the control device 4, respectively.

In step S200 in FIG. 12, it is determined whether the sensor data has been registered in the system, and when the sensor data has been registered in the system, the process proceeds to step S201.

In step S201, it is determined whether data concerning the operating plan and the operational change has been registered in the system, and when the data concerning the operating plan and the operational change has been registered in the system, the process proceeds to step S202.

In step S202, the data registered in steps S200 and S201 is read out.

In step S203, the area risk value calculating section 113 of the risk area setting unit 111 calculates an area risk value for each area in the field area.

In step S204, the risk area detecting section 115 of the risk area setting unit 111 executes a risk area setting process.

In step S205, the vehicle route setting unit 117 executes a vehicle rerouting process on the basis of the risk area set in step S204.

In step S206, the information display unit 119 displays the area risk value calculated in step S203, the risk area set in step S204, the traveling route set (rerouted) in step S205, and the like.

In the risk area setting process of step S204, in step S300 of FIG. 13, the area risk value before update for the entire area is acquired from the area risk value data.

In step S301, the area risk values before and after the update for the entire area are compared with each other.

In step S302, it is determined whether the area risk value has increased by a certain amount after the update compared with that before the update (whether the increase in the area risk value has exceeded a predetermined amount of change). When the value has increased by a certain amount, the process proceeds to step S303, where the range of the risk area is set based on the risk type in the area risk value (FIGS. 4 and 6), and the process proceeds to step S304. When the value has not increased by a certain amount, the process skips step S303 and proceeds to step S304.

In step S304, it is determined whether the area risk value has decreased by a certain amount after the update compared with that before the update (whether the amount of decrease in the area risk value of the predetermined area set as the risk area exceeds a predetermined amount of change). When the value has decreased by a certain amount, the process proceeds to step S305, where the range of the risk area is set to be reduced according to the risk type (FIGS. 4 and 7). When the value has not decreased by a certain amount, step S305 is skipped and the risk area setting process is terminated.

As described above, the automated driving system 1 of the present embodiment is provided with the operational information database 101 that records operational information related to operating plans or operational changes in a field area, the infrastructure information database 103 that records infrastructure information from the infrastructure sensors 3 in the field area, the risk area setting unit 111 that identifies a risk type from field information on planning or operation, recorded in the operational information database 101 and the infrastructure information database 103, and sets a predetermined area of the field area, as a risk area, on the basis of the risk type, and the vehicle route setting unit 117 that sets a traveling route for the vehicle 2 on the basis of vehicle position information of the vehicle 2 traveling in the field area and the risk area set by the risk area setting unit 111.

The risk area setting unit 111 calculates an area risk value based on the risk type for each predetermined area in the field area, and sets the predetermined area identified based on the risk type and the area risk value as the risk area.

The risk area setting unit 111 identifies a predetermined area in which the increase in the area risk value exceeds a predetermined amount of change, as a detection area, and sets the predetermined area identified based on the detection area and the risk type that constitutes the area risk value of the detection area (in combination with the risk type), as the risk area.

The risk area setting unit 111 has the risk area range database 105 that records a risk area range setting table that sets the range of the risk area on the basis of the risk type and the area risk value, and sets the range of the risk area on the basis of the risk area range setting table recorded in the risk area range database 105.

When the amount of decrease in the area risk value of the predetermined area set as the risk area exceeds a predetermined amount of change, the risk area setting unit 111 resets the risk area.

When the amount of decrease in the area risk value of the predetermined area set as the risk area exceeds a predetermined amount of change, the risk area setting unit 111 (partially) excludes the predetermined area from the risk area.

In other words, the automated driving system 1 of the present embodiment identifies a risk type from field information on planning or operation, calculates an area risk value on the basis of the risk type in the field area (area risk value calculating section 113), detects or sets a risk area on the basis of the risk type and the area risk value (risk area detecting section 115), and sets a vehicle traveling route on the basis of the risk area (vehicle route setting unit 117).

According to the present embodiment, risk types are identified from field information and risk areas are set from the field area, so that risk areas can be set accurately to achieve safe automated driving.

It should be noted that the present invention is not limited to the above-described embodiment, and includes various modified forms. For example, the above-described embodiment has been described in detail to clearly describe the present invention, and the present invention is not necessarily limited to the embodiment having all of the described configurations.

In addition, the above-mentioned configurations, functions, processing units, processing means, etc., may be achieved in part or in whole by hardware, for example, by designing using integrated circuits. In addition, the above-mentioned configurations, functions, etc., may be achieved by software by a processor interpreting and executing a program that fulfills each function. Such information as a program, a table, or a file that implements each function can be stored in a storage device such as a memory, a hard disk, or an SSD (Solid State Drive), or a recording medium such as an IC card, an SD card, or a DVD.

In addition, the control lines and the information lines illustrated are those that are considered necessary for the description, and not all control lines and information lines in the product are necessarily illustrated. In reality, it can be considered that almost all components are connected to each other.

### DESCRIPTION OF REFERENCE SYMBOLS

1: Automated driving system
2: Vehicle
3: Infrastructure sensor
4: Control device
101: Operational information database (DB)
102: Risk type database (DB)
103: Infrastructure information database (DB)
105: Risk area range database (DB)
107: Area risk value list database (DB)
109: Vehicle route list database (DB)
111: Risk area setting unit
113: Area risk value calculating section
115: Risk area detecting section
117: Vehicle route setting unit
119: Information display unit

1.-10. (canceled)

11. An automated driving system comprising:
an operational information database that records operational information relating to an operating plan or an operational change in a field area;
an infrastructure information database that records infrastructure information from an infrastructure sensor in the field area;
a risk area setting unit that identifies a risk type from field information on planning or operation, recorded in the operational information database and the infrastructure information database, and sets a predetermined area of the field area, as a risk area, based on the risk type; and
a vehicle route setting unit that sets a traveling route for a vehicle traveling in the field area, based on vehicle position information of the vehicle and the risk area set by the risk area setting unit,
wherein the risk area setting unit calculates an area risk value based on the risk type for each predetermined area of the field area, and sets the predetermined area identified based on the risk type and the area risk value as the risk area.

12. The automated driving system according to claim 11, wherein
the risk area setting unit identifies a predetermined area where an increase in the area risk value exceeds a predetermined amount of change as a detection area, and sets the predetermined area identified based on the detection area and the risk type that constitutes the area risk value of the detection area, as the risk area.

13. The automated driving system according to claim 11, wherein
the risk area setting unit has a risk area range database that records a risk area range setting table that sets a range of the risk area, based on the risk type and the area risk value, and sets the range of the risk area, based on the risk area range setting table recorded in the risk area range database.

14. The automated driving system according to claim 11, wherein
the risk area setting unit resets the risk area when an amount of decrease in the area risk value of the predetermined area set as the risk area exceeds a predetermined amount of change.

15. The automated driving system according to claim 11, wherein
the risk area setting unit excludes the predetermined area set as the risk area from the risk area when an amount of decrease in the area risk value of the predetermined area exceeds a predetermined amount of change.

16. The automated driving system according to claim 11, wherein
the vehicle route setting unit sets a traveling route for the vehicle located in the risk area, based on a first condition, and sets a traveling route for the vehicle located outside the risk area, based on a second condition different from the first condition.

17. The automated driving system according to claim 16, wherein
the vehicle route setting unit sets a traveling route for the vehicle that is scheduled to travel from outside the risk area into the risk area, based on a third condition that is different from the first condition and the second condition.

18. A method for regulating driving, comprising:
an operational information recording step of recording operational information relating to an operating plan or an operational change in a field area;
an infrastructure information recording step of recording infrastructure information from an infrastructure sensor in the field area;
a risk area setting step of setting a predetermined area of the field area, as a risk area, based on a risk type, after identifying the risk type from field information on planning or operation, recorded in the operational information recording step and the infrastructure information recording step; and
a vehicle route setting step of setting a traveling route for a vehicle traveling in the field area, based on vehicle position information of the vehicle and the risk area set in the risk area setting step,
wherein the risk area setting step calculates an area risk value based on the risk type for each predetermined area of the field area, and sets the predetermined area identified based on the risk type and the area risk value as the risk area.

19. A driving regulation program for causing a computer to execute:
an operational information recording procedure of recording operational information relating to an operating plan or an operational change in a field area;
an infrastructure information recording procedure of recording infrastructure information from an infrastructure sensor in the field area;
a risk area setting procedure of setting a predetermined area in the field area, as a risk area, based on a risk type, after identifying the risk type from field information on planning or operation, recorded in the operational information recording procedure and the infrastructure information recording procedure; and
a vehicle route setting procedure of setting a traveling route for a vehicle traveling in the field area, based on vehicle position information of the vehicle and the risk area set in the risk area setting step,
wherein the risk area setting procedure calculates an area risk value based on the risk type for each predetermined area of the field area, and sets the predetermined area identified based on the risk type and the area risk value as the risk area.
